(19) United States
(12) Patent Application Publication
(10) Pub. No.: US 2026/0336717 A1
(43) Pub. Date: Oct. 29, 2026

(54) SPRAY SUPPRESSION DEVICE

(71) Applicants: Ambroz Uriah NEIL, Greater London (GB); Marcus-Alexander NEIL, Greater London (GB)

(72) Inventors: Ambroz Uriah NEIL, Greater London (GB); Marcus-Alexander NEIL, Greater London (GB)

(21) Appl. No.: 19/106,976

(22) PCT Filed: Sep. 13, 2023
(86) PCT No.: PCT/EP2023/075137

§ 371 Date: Feb. 26, 2025

(30) Foreign Application Priority Data
Sep. 14, 2022 (GB) 2213476.1

(51) Int. Cl. B62D 25/18

(52) U.S. Cl. CPC B62D 25/188

(57) ABSTRACT

There is provided a spray suppression device (100). The spray suppression device (100) is attachable to a vehicle (210) and may be used for controlling spray, including blocking and redirecting the spray, from a wheel (215) of the vehicle (210) in motion on a wet surface. The device (100) comprises: an inlet (105) for receiving an airflow; an expansion portion (120) expanding in a direction away from the inlet (105) for decreasing a velocity of the airflow received at the inlet (105); an angled portion (130) for directing the airflow from the expansion portion (120) at an angle different to the angle of the airflow received at the inlet (105); and an outlet (140) that generates an air blade.

### FIELD

The present disclosure relates to a spray suppression device. In particular, the present disclosure relates to a spray suppression device for directing splash and spray which occurs when vehicles travel along a wet surface.

### BACKGROUND

Water spraying from heavy vehicles in rainy weather is a serious threat to all drivers, especially on motorways and expressways. Overtaking drivers are at risk of a complete lack of visibility. It is also a risk for drivers of lorries and trailers, their visibility to the rear may be very limited.

It is commonly accepted that the splash and spray generated by motorised vehicles of all shapes and sizes pose a tangible threat to road safety. Splash and spray are however significantly more pronounced with larger vehicles such as trucks and lorries.

The phrase “splash and spray” is commonly used to describe what happens when motor vehicles travel on wet roads. Splash is caused when water is pushed out from the tire patch (contact patch) towards the sidewall of the tire. Spray is when water is forced into the tread pattern, between the tire and the road surface, becoming airborne upon tire rotation; this is the water that is displaced vertically from behind the tire.

Splash and spray can adversely affect driver visibility. From 1500 feet on dry roads, visibility can be reduced to just 300-600 feet in rainy conditions. In addition to reduced visibility, a driver may become surprised and confused when splash and spray hit their windscreens.

Two principle methods exist for tackling splash and spray. These are:
(i) Windscreen wipers—These can be ineffective in very wet conditions because the resulting spray clouds are suspended in the air around the vehicle.
(ii) Suppression/inhibiting devices—Designed to be either energy absorbing or to separate the water from the air-water mix.

Various suppression devices have been developed and are widely used. However, in the field many do not deliver and those that do could be improved. Designs include slotted or textured mudflaps, broom-like suppression skirting mounted above drive and trailer axles designed to keep the water from the wheels from escaping into the slipstream.

Presently, splash and spray suppression systems comprise a combination of a rigid or semi-rigid components intended to collect the water that is thrown up from the moving tyres (mudguard), flexible material fitted behind the wheels (splash guard) and a splash protection mat/spray reduction device. Whilst these devices in practice do help to reduce the splash and spray that drivers experience, there is room for improvement.

There is therefore a need to provide a device that increases road safety by improving a driver or drivers visibility which can be reduced as result of the effects of splash and spray during periods of heavy rain compared to existing systems.

### SUMMARY

According to a first aspect, there is provided a spray suppression device. The spray suppression device is attachable to a vehicle and may be used for controlling spray from a wheel of the vehicle in motion on a wet surface. The device comprises: an inlet for receiving an airflow; an expansion portion expanding in a direction away from the inlet for decreasing a velocity of the airflow received at the inlet; an angled portion for directing the airflow from the expansion portion; and an outlet. Controlling the spray may include blocking and/or redirecting the spray in a direction away from other road users. The angled portion may direct the airflow away from the expansion portion at an angle different to the angle of the airflow received at the inlet.

The spray suppression device works by creating an air blade (or air barrier) that is directed over the wheels of the vehicle, for example at position behind the wheels, to block and/or redirect the spray created. The air blade is created by an airflow which is drawn into/flows into the spray suppression device as the vehicle travels along the road. The air entering the device is first subjected to the expansion portion, which expands in the direction of the airflow. This slows down the airflow and increases the pressure inside the device. After this, at the angled portion the airflow is directed towards the outlet. The air in the angled portion increases in pressure and decreases in velocity such that when it is forced out of the outlet, it creates an air barrier (or air blade). The resulting air blade prevents spray, for example a spray cloud, from negatively affecting vehicles nearby by reducing the extent to which the visibility of drivers in said vehicles is reduced. Preferably, the air blade created by the spray suppression device extends to the road surface leaving no gap for the water (spray) to pass through or under.

In some embodiments, the inlet may have a larger cross-sectional area than the outlet. This arrangement helps to increase the pressure and decrease the velocity of the airflow inside the spray suppression device to create the air blade at the outlet. Optionally, a ratio of the cross-sectional area of the inlet to the outlet may be 2.4:1, however, any suitable ratio may be used which is greater than 1:1.

In some embodiments, the angled portion may have a decreasing cross-sectional area in the direction away from the inlet, towards the outlet. This increases the pressure of the airflow as it moves towards the outlet by decreasing the velocity of the airflow (to maintain conservation of mass) before it is forced out of the outlet as an air blade.

In some embodiments, the expansion portion may have a cross-sectional area which increases in the direction away from the inlet, towards the outlet. This expansion in the direction of the airflow as the vehicle is in motion helps to slow down the airflow and increase the pressure. Optionally, the expansion portion may have curved walls.

In some embodiments, the device may further comprise a funnel portion for directing the airflow from the inlet to the expansion portion. Optionally, the funnel portion may have a constant width along its length. Optionally, the funnel portion may have a same cross-sectional area as the inlet. The funnel portion directs air into the expansion portion from where on the vehicle the device is attached. Air pressure, density and velocity remain mostly constant through the funnel portion.

In some embodiments, the angled portion has a constant width along its length.

In some embodiments, the outlet has a width approximate to the width of the vehicle. This will ensure that the spray suppression device is roughly the same width as the vehicle to which it is attached.

In some embodiments, the angled portion is angled at between 50 and 70 degrees from the direction of airflow from the inlet. In some embodiments, the angled portion is angled at 60 degrees from the direction of airflow from the inlet. This angle projects the air blade onto the road and over the wheels at a position just behind the wheels themselves, to reduce the effect of spray from the wheels reducing the visibility of drivers in nearby vehicles.

In some embodiments, the outlet may be a slit. The air flow which continuously enters the spray suppression device at the inlet forces the air out of the outlet at the opposite end of the spray suppression device. The outlet should be thin to create an air blade.

In some embodiments, the device may further comprise an attachment mechanism for attaching the device to the underside of the vehicle.

According to a second aspect there is provided a vehicle comprising the spray suppression device according to the first aspect.

In some embodiments, the airflow is received into the inlet parallel to a direction of motion of the vehicle. For example, with the inlet facing the forward direction of motion of the vehicle. This ensures that the airflow is received through the inlet at the correct angle.

In some embodiments, the angled portion is angled to direct an air barrier over and/or behind a wheel of the vehicle.

In some embodiments, the spray suppression device is positioned behind one or more wheels of the vehicle.

In some embodiments, the spray suppression device is positioned behind rearmost wheels of the vehicle.

### BRIEF DESCRIPTION OF DRAWINGS

A more complete understanding of the subject matter may be derived by referring to the detailed description and claims when considered in conjunction with the following figures, wherein like reference numbers refer to similar elements throughout the figures.

FIG. 1 illustrates a side-view of a spray suppression device according to the present disclosure;

FIG. 2 illustrates the spray suppression device from a head-on view;

FIGS. 3A and 3B illustrate the spray suppression device from above and below respectively;

FIG. 4A and FIG. 4B illustrate the spray suppression device as attached to a vehicle;

FIG. 5 illustrates an example of an airflow according to an embodiment of the present disclosure.

### DETAILED DESCRIPTION

The following detailed description is merely illustrative in nature and is not intended to limit the embodiments of the subject matter or the application and uses of such embodiments. As used herein, the words “exemplary” and “example” mean “serving as an example, instance, or illustration.” Any implementation described herein as exemplary or an example is not necessarily to be construed as preferred or advantageous over other implementations. Furthermore, there is no intention to be bound by any expressed or implied theory presented in the preceding technical field, background, or the following detailed description.

Water is ejected by tyres travelling at speed on a wet road producing splash and spray. The extent of this is influenced by tyre design, vehicle design (including aerodynamics), the airflow, and road surface design.

Tyre design: Road traction is the overriding principal design focus, superseding the need to suppress splash and spray. Little progress has been made by the leading tyre manufacturers on tyre design that substantially reduce vehicle splash and spray.

Aerodynamics: The design of a vehicle affects the airflow and so the extent of splash and spray. However, the cost of establishing sufficiently aerodynamic designs represents an unrealistic overarching long-term solution to the problem of splash and spray.

Airflow: The movement of air above, beneath a moving vehicle and around the tyres contribute to the problem of splash and spray.

The road: The amount of free water on roads contribute to splash and spray. Roads are designed primarily to maximise traction (enabling shorter stopping distances, improving vehicle stability). Improvements in many of these features will tend to increase the severity of splash and spray.

In summary, the size, configuration, and weight of a vehicle and the size, design, pressure, and condition of its tyres play a role in the problem of splash and spray. As vehicle size increases, so too does the air turbulence it creates. Vehicle weight also contributes to splash and spray by affecting the force with which the tyres strike water on the road, a heavier weight results in a greater force and more splash. The size and design of the tyres determine the amount of water displaced, picked up, and spilled from the tyres. Tyre design that achieves the most traction also tend to pick up the most water and therefore produce more splash and spray.

A spray suppression device is described herein that aims to help solve the problem of reduced visibility to nearby drivers caused by splash and spray. This is achieved by directing an air blade (e.g. an air barrier) over and/or behind the wheels of a vehicle to block/redirect the distribution of the water which is displaced from the wheel in motion and that forms spray. For example, the water may be redirected to the ground. The terms “air blade” and “air barrier” are used interchangeably herein.

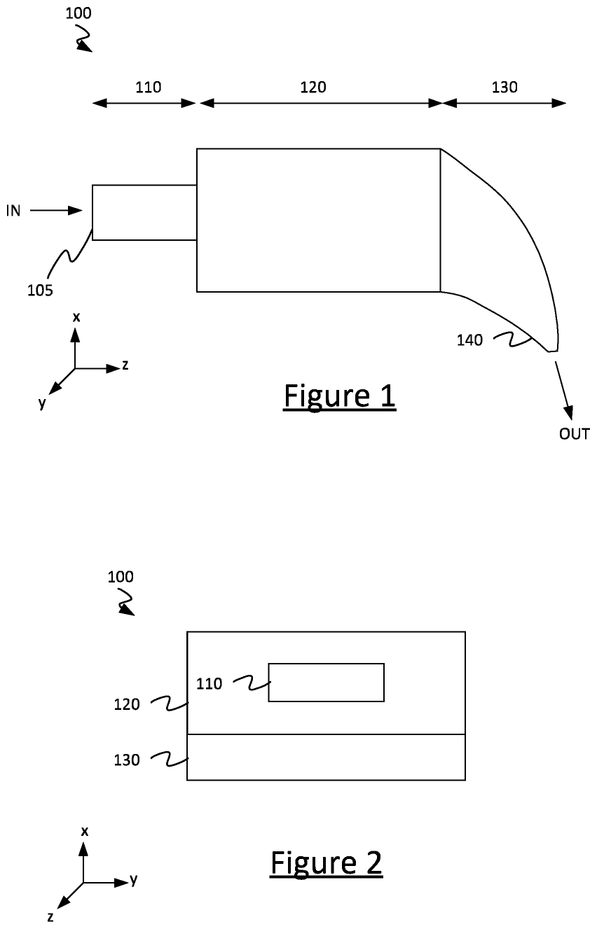

FIG. 1 illustrates a side-view of a spray suppression device 100 according to the present disclosure. The spray suppression device 100 comprises an inlet 105, a funnel portion 110, an expansion portion 120, an angled portion 130, and an outlet 140. Air flowing though the spray suppression device 100 will travel through the portions sequentially in the order described above.

An airflow is received at the inlet 105. The airflow may be received from air travelling around a vehicle in motion, the spray suppression device 100 being attached to the vehicle. The spray suppression device may be attached to an underside of the vehicle in a preferred embodiment. In other embodiments, the spray suppression device 100 could be attached to a side of the vehicle or a top of the vehicle, for example.

The funnel portion 110 has a length A_{L} (in a z direction), a height A_{H} (in an x direction) and a width A_{W} (in a y direction). The funnel portion 110 has a constant width A_{W} along it's length A_{L}. The funnel portion 110 funnels air from the inlet 105 to the expansion portion 120. The airflow travelling along the funnel portion 110 has a constant density, velocity and pressure.

When the device 100 is attached to a moving vehicle, an air stream readily flows into the funnel portion 110 via the inlet 105. The spray suppression device 100 may work without the funnel portion 110, however, performance is generally better with it. In some examples, it may be helpful to attach a filter to the funnel portion to improve longevity of the spray suppression device 100.

The expansion portion 120 has a length B_{L} (in a z direction), a height B_{H} (in an x direction) and a width B_{W} (in a y direction). The expansion portion 120 has an increasing width B_{W} along its length in the z direction. The height B_{H} of the blade formation portion 120 is greater than the height A_{H} of the funnel portion 110 from which the airflow is received, and remains constant along the length of the expansion portion 120. The length of the expansion portion 120 B_{L} is longer than the length A_{L} of the funnel portion 110.

When the airflow is received from the funnel portion 110 into the expansion portion 120 it is received at approximately a same velocity of the vehicle. Due to an increasing volume of the expansion portion 120 the airflow through the expansion portion 120 is forced into an expanding area. This acts to decrease the velocity of the airflow and increase the pressure.

The angled portion 130 has a length C_{L} (in a z direction), a height C_{H} (in an x direction) and a width C_{W} (in a y direction). The width C_{W} is the same as the width B_{W} of the expansion portion 120 at its widest (e.g. at an end closest to the outlet).

The angled portion 130 receives the airflow from the expansion portion 120. In an embodiment where the spray suppression device is attached to an underside of a vehicle, the angled portion 130 curves away from the horizontal towards the road when it is installed on the vehicle and directs the air to the outlet 140. As the airflow is received in a direction parallel to the undercarriage of a vehicle to which it is attached in this arrangement, in order to reduce/redirect splash or spray from the wheels to improve the visibility of drivers in nearby vehicles, the air blade needs to be angled away from the direction in which it is received. The angle at which the angled portion outputs the air blade may depend on a number of factors. A suitable angle for the air blade to be output will result in a change of angle between zero and 90 degrees from the original angle of the airflow received. However, an angle between 20 and 40 degrees from vertical may be preferable, for example an angle of 30 degrees from vertical (e.g. a deviation of 60 degrees from the horizontal angle the airflow is received at). In one example, where the spray suppression device 100 is positioned on an underside of the vehicle, a 30 degree angle may be preferable because it provides a balance between directing spray away from a vehicle behind, directing spray away from the wheel, and blocking the spray before it gets too high off the ground.

In another example, the spray suppression device 100 may be positioned on a side of a vehicle to direct an air blade along the side of the vehicle and so an angle of zero degrees may be preferable in this case. In yet another example, the spray suppression device 100 may be positioned on the roof of the vehicle. In this case, an angle closer to 90 degrees may be more appropriate.

The angled portion 130 has a decreasing cross-sectional area in the direction of the outlet. This increases the velocity of the airflow towards the outlet 140 as it is forced back into a smaller area after the expansion portion 120.

An air blade which is formed by the combined portions of the spray suppression device 100 is output through the outlet 140. A cross-sectional area of the outlet 140 is smaller than the cross-sectional area of the inlet 105. In one example, the cross-sectional area of the outlet 140 may be four times smaller than the cross-sectional area of the inlet 105, though any suitable ratio for creating an air blade through the outlet may be used. This arrangement increases the velocity of the airflow creating an air blade through the outlet 140.

FIG. 2 illustrates the spray suppression device 100 from a head-on view. As can be seen the funnel portion 110 is placed centrally to the width B_{W} and height B_{H} of the expansion portion 120. The expansion portion 120 has a greater final width than the funnel portion 110. The angled portion 130 can be seen to extend below the expansion portion 120.

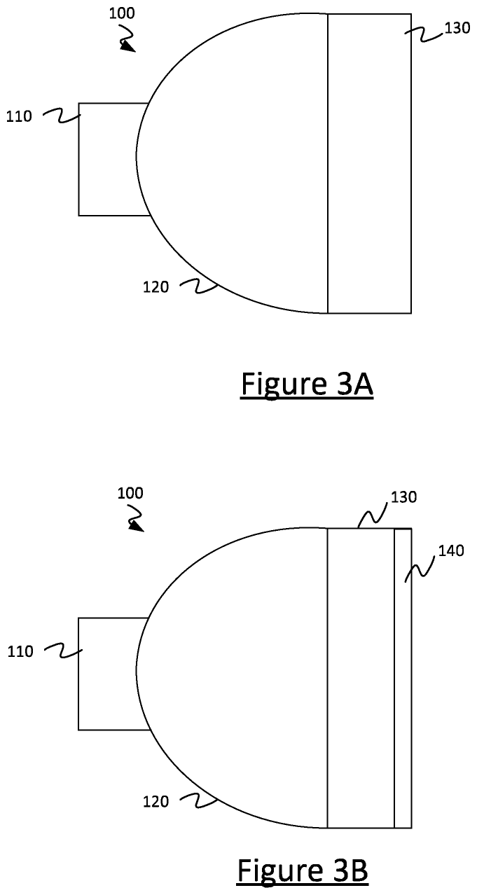

FIGS. 3A and 3B illustrate the spray suppression device 100 from above and below respectively. FIGS. 3A and 3B illustrate in particular the expansion portion 120 and the increasing width of this portion. The main difference between the above and below view of the spray suppression device 100 is that the outlet 140 can be seen in FIG. 3B illustrating the view from below. The outlet 140 being in a plane perpendicular to the inlet 110.

The spray suppression device 100 can be attached to the underside of a vehicle using any appropriate attachment mechanism. For example, the spray suppression device 100 maybe bolted to the vehicle.

The design of the spray suppression device 100 considers three scientific concepts:
(i) Bernoulli's Principle,
(ii) Scoop/positive intake device, and
(iii) Air blade.

Bernoulli's Principle states that for a given volume of air, the higher the velocity the lower the pressure. Conversely, for a given volume of air, the lower the velocity the higher the pressure.

Air naturally flows around a moving object. As the speed of the object increases the surrounding airflow will have an increasing effect on factors such as vehicle acceleration and maximum speed. For a moving vehicle it is established that:
1. The velocity of the surrounding air is not constant,
2. There is a low-pressure, high-velocity air stream between the underside of a vehicle and the road,
3. There is a low-pressure region at the rear.

The airflow through the spray suppression device 100 remains at a constant density. A mass of the airflow out of the spray suppression device 100 must equal the mass of the airflow into the spray suppression device 100 according to Bernoulli's principle. So, as the cross-sectional area decreases, velocity increases to keep the mass of the air flow constant and vice versa. The combined design of the expansion portion 120 and the angled portion 130 act to create a high velocity airflow at the outlet 140 such that an air blade is created.

A scoop, or positive pressure intake device, is used to deliver a high velocity air stream to engines. A constant and oncoming flow of air is compressed inside an “air box”. The air box has a region of expansion which slows the airflow, increasing the pressure inside the box. The compressed air is then funneled through a narrow exit, delivering a high velocity air stream. The faster the vehicle travels the greater the pressure increase and air volume through the air box, and the greater the velocity of air leaving the narrow-funneled exit. The same concept is used in the spray suppression device 100.

An air blade is a pressurized air plenum chamber with a continuous slot through which pressurized air exits in a laminar (uniform) flow pattern, creating an air velocity in the form of an air barrier. Air blades can be used for drying and removing liquid films from product surfaces, blowing off dust and dirt, sorting material using air, or providing an air curtain, for example. An air blade is formed by the spray suppression device 100 described herein.

The spray suppression device 100 provides a positive pressure intake device that captures and converts air that flows around the vehicle into an air blade type barrier that blocks and redirects the spray from the wheels of the vehicle from rising to the windscreen of the vehicle following behind and/or to the sides. Some further advantages are provided by the spray suppression device 100. For example, there are no moving parts, so the device is robust. No electricity is required to use the device which makes it safe, and allows for easy installation. It is self-regulating (the greater the vehicle speed, the more intense the spray but also the stronger the resulting air barrier). The air barrier may extend to the road surface, which leaves little to no gap for the spray to pass through or under.

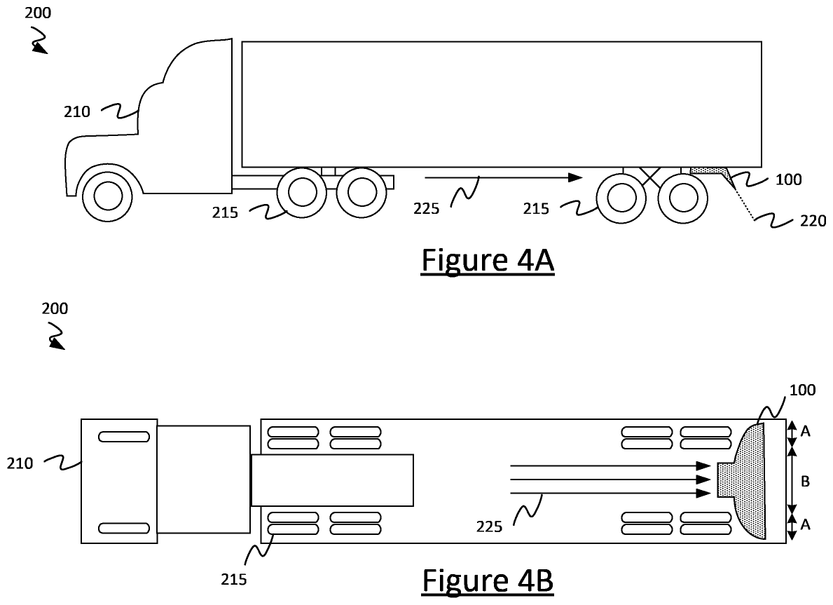

FIG. 4A and FIG. 4B illustrate the spray suppression system 200 comprising the spray suppression device 100 as attached to a vehicle 210 comprising wheels 215. In this illustration, the spray suppression device 100 is attached to the vehicle 210 towards the rear. As illustrated, the spray suppression device 100 is attached to prevent spray and splash primarily from the rearmost wheels 215. In some examples, a further spray suppression device 100 may also be attached towards the front of the vehicle 210 behind the front tyres or after the middle set of tyres, although these have not been illustrated here.

As the vehicle 210 travels along a road, an airflow 225 flows underneath the vehicle 210. This airflow 225 is received at the inlet 105 of the spray suppression device 100.

FIG. 4B illustrates sections A and B at the rear of the vehicle 210. Section A relates to a portion of the rear of the vehicle 210 which is directly behind the wheels 215. Section B relates to a portion of the rear of the vehicle 210 which is not directly behind a wheel. Section A is not subjected to the same air velocity or spray generation as B because of the tyres.

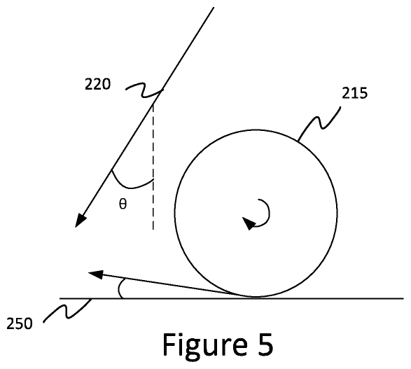

FIG. 5 illustrates a wheel 215 turning clockwise along a road surface 250, as if a vehicle was moving from left to right. The air blade 220 produced by the spray suppression device 100 is angled at θ degrees to the vertical. Spray from water interacting with the wheel 215 is angled at φ degrees from the horizontal. In one example, θ=30 degrees and φ=5 degrees.

### WORKED EXAMPLE

In this example, we consider a spray suppression device 100 attached to the underside of a heavy goods vehicle (HGV) as illustrated in FIGS. 4A and 4B.

In this example, the height A_{H} of the funnel portion 110 is around 5 cm, the width A_{W} is around 30 cm and the length A_{L} is around 20 cm. A cross-sectional area of the inlet 105 is therefore around 150 cm². The height B_{H} of the expansion portion 120 is around 10 cm, the width B_{W} expands from around 30 cm to 250 cm and the length B_{L} is around 30 cm. The height C_{H} of the angled portion 130 is around 15 cm in total from top to bottom, the width C_{W} is around 250 cm and the length C_{L} is around 10 cm. The outlet 140 is a very thin slot of 0.25 cm in width, with a cross-sectional area of around 62.5 cm².

Applying Bernoulli's equations to the inlet 105 and outlet 140 of the spray suppression device 100, assuming minimum impact of air density, the velocity of the air leaving the spray suppression device 100, V(out), can be calculated using:

$$V ( out ) = \frac{A ( in )}{A ( out )} V ( in )$$

Where V(in) is the air velocity received into the spray suppression device 100 at the inlet 105, V(out) is the air velocity out of the outlet 140, and A(in) and A(out) are the cross-sectional areas of the inlet 105 and outlet 140 respectively.

The above example produces an A(in):A(out) ratio of 2.4:1, and taking the vehicle, and therefore the air under the vehicle, to be travelling at approximately 30 m/s (around 68 mph), the velocity of the air barrier created by the spray suppression device 100 will be around 72 m/s. This should be sufficient to provide an air barrier right down to the road surface, preventing spray from passing said barrier.

Whilst the present disclosure has been described in relation to a vehicle travelling on a wet surface, it will be appreciated that the spray suppression device could be used to a similar effect in other situations. For example, the device may be useful on dry surfaces such as those which are dusty or sandy.

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not drawn to scale.

The present invention may be embodied in other specific forms without departing from its essential characteristics. The described embodiments are to be considered in all respects only as illustrative and not restrictive. The scope of the invention is, therefore, indicated by the appended claims rather than by this detailed description.

Reference throughout this specification to features, advantages, or similar language does not imply that all of the features and advantages that may be realised with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognised in certain embodiments that may not be present in all embodiments of the invention.

1. A spray suppression device attachable to a vehicle and for controlling spray from a wheel of the vehicle in motion on a wet surface, the device comprising:
an inlet for receiving an airflow;
an expansion portion expanding in a direction away from the inlet;
an angled portion for directing the airflow from the expansion portion; and
an outlet.

2. The device of claim 1, wherein the inlet has a larger cross-sectional area than the outlet.

3. The device of claim 2, wherein a ratio of the cross-sectional area of the inlet to the outlet is 2.4:1.

4. The device of claim 1, wherein the angled portion has a decreasing cross-sectional area in the direction away from the inlet, towards the outlet.

5. The device of claim 1, wherein the expansion portion has a cross-sectional area which increases in the direction away from the inlet, towards the outlet.

6. The device of claim 5, wherein the expansion portion has curved walls.

7. The device of claim 1, further comprising a funnel portion for directing the airflow from the inlet to the expansion portion.

8. The device of claim 7, wherein the funnel portion has a constant width along its length.

9. The device of claim 8, wherein the funnel portion has a same cross-sectional area as the inlet.

10. The device of claim 1, wherein the angled portion has a constant width along its length.

11. The device of claim 1, wherein the outlet has a width approximate to the width of the vehicle.

12. The device of claim 1, wherein the angled portion is angled at between 50 and 70 degrees away from the direction of airflow from the inlet.

13. The device of claim 1, wherein the angled portion is angled at 60 degrees away from the direction of airflow from the inlet.

14. The device of claim 1, wherein the outlet comprises a slit.

15. The device of claim 1, further comprising an attachment mechanism for attaching the device to the vehicle.

16. A vehicle comprising the spray suppression device of claim 1.

17. The vehicle of claim 16, wherein the airflow is received into the inlet parallel to a direction of motion of the vehicle.

18. The vehicle of claim 16, wherein the angled portion is angled to direct an air barrier over and/or behind a wheel of the vehicle.

19. The vehicle of claim 16, wherein the spray suppression device is positioned behind one or more wheels of the vehicle.

20. The vehicle of claim 19, wherein the spray suppression device is positioned behind rearmost wheels of the vehicle.
